(19) United States
(12) Patent Application Publication
(10) Pub. No.: US 2012/0191666 A1
(43) Pub. Date: Jul. 26, 2012

(54) 3D DATA RECOVERY DEVICE, 3D DATA RECOVERY METHOD, AND 3D DATA RECOVERY PROGRAM

(75) Inventor: TOSHINARI SUMA, Osaka (JP)

(73) Assignee: PANASONIC CORPORATION, Osaka (JP)

(21) Appl. No.: 13/153,792

(22) Filed: Jun. 6, 2011

(30) Foreign Application Priority Data
Jan. 21, 2011 (JP) 2011-010395
May 20, 2011 (JP) 2011-113367

(51) Int. Cl. G06F 17/30

(52) U.S. Cl. 707/690; 707/E17.007

(57) ABSTRACT

A problem is that if one of the recording mediums is media formatted and management information is deleted, etc. when left-eye image (ex. first data) and right-eye image (ex. second data) constituting 3D data are recorded to different recording mediums, then 3D image cannot be properly reproduced. A 3D data recovery device comprises interfaces 103, 104 for accessing first and second data recording mediums 101, 102 on which first data and second data constituting 3D data are recorded, a management information acquisition unit that acquires data management information on the first data recording medium 101 if data management information on the second data recording medium 102 is unavailable, a data acquisition unit that acquires the first and second data recorded to the first and second data recording mediums 101, 102 based on the management information acquired from the first data recording medium 101, and a data check unit that determine whether the acquired data is valid based on the first and second data acquired from the first and second data recording mediums 101, 102.

### CROSS-REFERENCE TO RELATED APPLICATIONS

This application claims priority to Japanese Patent Application No. 2011-010395, filed on Jan. 21, 2011 and Japanese Patent Application No. 2011-113367, filed on May 20, 2011. The entire disclosures of Japanese Patent Application No. 2011-010395 and No. 2011-113367 are hereby incorporated herein by reference.

### BACKGROUND

1. Technical Field

The technology disclosed herein relates to a 3D data recovery device that recovers 3D data if part of two sets of data constituting 3D data recorded on two recording mediums is unavailable. The technology also relates to a 3D data recovery method which recovers the 3D data and a 3D data recovery program to execute the 3D data recovery method.

2. Background Information

Considerable attention has been focused on imaging devices that obtain 3D video by independently capturing left-eye video and right-eye video in a synchronizable fashion. The way a 3D video is viewed is based on the basic principle which gives the user the impression of 3D by utilizing the parallax between the left and right eyes.

3D video is composed of left-eye video and right-eye video. A recording system has been proposed in which left-eye video and right-eye video are each recorded on a different recording medium, and in which left-eye video and right-eye video are both recorded on the same recording medium.

JP-H8-32871 discloses a multi-lens imaging device in which left video is recorded on a memory unit and right video is recorded on another memory unit. Each of the video signals inputted from the left and right imaging systems is processed by a video signal processing circuit, and then processed by A/D conversion technique. Each of the A/D-converted video signals is then written by a memory controller as data to each of two memory units. When the data written to each of the memory units is then read out, that data is compressed by being thinned according to a compression ratio set on a selector. This compressed data is processed by D/A conversion technique via a selector circuit and is converted to a specific format and recorded by a recording and reproduction process unit. Reproduction signals are written from the recording and reproduction process unit to the two memory units, and are read out while being expanded at the two memory units. These reproduction signals undergo D/A conversion from a selector circuit, and then are converted into display signals by a display signal production unit, and are outputted to a monitor.

With a conventional multi-lens imaging device, if left-eye video and right-eye video were recorded on different recording mediums, there was the risk that one of the recording mediums would be subjected to media formatting, or that the management information of one of the recording mediums would be deleted, or the like due to accidental operation by the user, for example. A problem in such a case is that the 3D video cannot be properly reproduced.

### SUMMARY

To solve the above problem, the 3D data recovery device comprises a recording medium control unit, a management information acquisition unit, a data acquisition unit, and a data check unit. The recording medium control unit is configured to access a first recording medium on which first data is recorded and a second recording medium on which second data is recorded. The first and second data constitute 3D data. The management information acquisition unit is configured to acquire management information related to the second data from the second recording medium if management information related to the first data on the first recording medium is unavailable. The data acquisition unit is configured to acquire the first data and second data recorded on the first and second recording mediums, respectively, based on the management information acquired from the second recording medium. The data check unit is configured to check a consistency of the first and second data as 3D data as 3D data and determine whether the first data acquired from the first recording medium is valid, based on information in the first and second data acquired from the first and second recording mediums, respectively.

With the above constitution, there are two sets of data which constitute 3D data and are respectively recorded on each of two recording mediums, and if the management information for one recording medium is unavailable, the data can be recovered by utilizing the management information for the other recording medium. Also, since management information is the only thing that is processed, the recovery processing can be completed in less time than if the data is recovered directly.

### BRIEF DESCRIPTION OF DRAWINGS

Referring now to the attached drawings which form a part of this original disclosure:

FIG. 1 is a block diagram of the configuration of the 3D data recovery device according to Embodiment 1;

FIG. 2 is a diagram of 3D data files on data recording mediums according to Embodiment 1, prior to media formatting;

FIG. 3 is a diagram of 3D data files on data recording mediums according to Embodiment 1, after media formatting;

FIG. 4 is a diagram of the state of 3D data files on recording mediums according to Embodiment 1, during over-writing over management information to the medium to be recovered;

FIG. 5 is a flowchart of the processing of the 3D data recovery device according to Embodiment 1; and

FIG. 6 is a diagram of 3D data files if part of the management information has been deleted from the data recording medium according to another embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the present technology as defined by the appended claims and their equivalents.

### First Embodiment

1: Configuration of Data Recovery Device

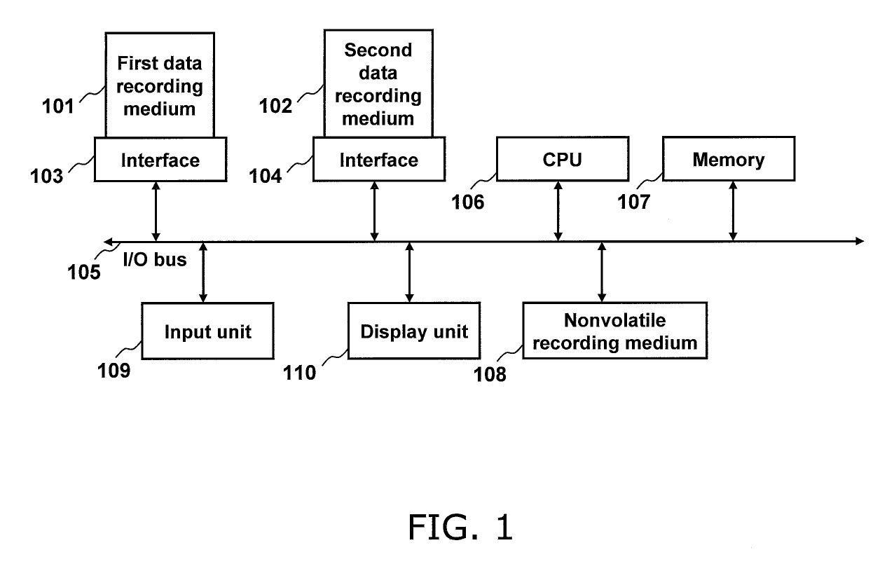

Embodiments will now be described through reference to the drawings. FIG. 1 is a block diagram of the configuration of the 3D data recovery device according to Embodiment 1. In FIG. 1, a first data recording medium 101 and a second data recording medium 102 are 3D data recording mediums. L/R (left and right) image data are independently recorded on the first data recording medium 101 and the second data recording medium 102, respectively. Here, the L/R image data constitutes the 3D data and are recorded in the same logical partitions of the first recording medium 101 and the second data recording medium 102. The first and second data recording mediums 101, 102 are a hard disk, an optical disc, a semiconductor memory or the like. The first and second data recording mediums 101, 102 may be constituted so that they can be attached to and removed from the 3D data recovery device, or may be built into the 3D data recovery device.

Interfaces 103, 104 can be electrically and mechanically connected to the first and second data recording mediums 101, 102. The interfaces 103, 104 transfer signals to an I/O bus 105 and receive signals from an I/O bus 105. A CPU 106 performs computation and control processing in the 3D data recovery device. The CPU 106 reads and executes programs recorded on a nonvolatile recording medium 108 and thereby executes various kinds of computation and processing. The memory 107 stores temporary data and data extracted from the first and second data recording mediums 101, 102. The nonvolatile recording medium 108 stores programs and so forth. The nonvolatile recording medium 108 is constituted by a hard disk or the like. The user instructs the 3D data recovery device to begin recovery processing by using an input unit 109. The user can also designate the medium on which recovery is to be performed by using the input unit 109. A display unit 110 displays the progress status of recovery processing executed by the CPU 106, the recovery processing results, and so on.

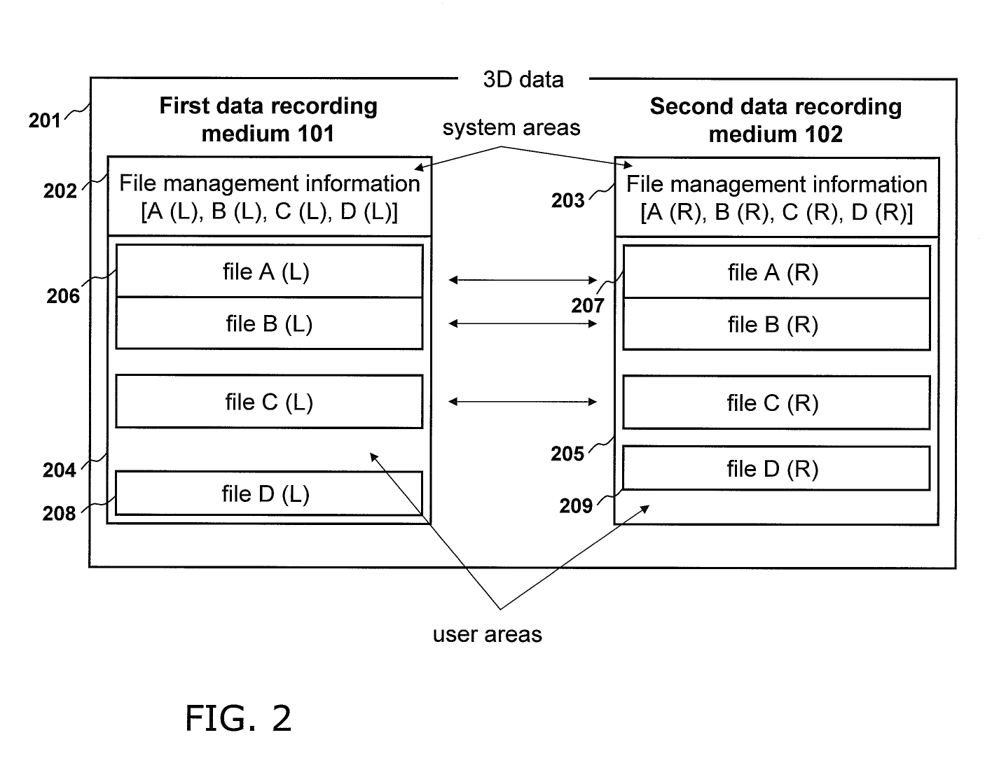

FIG. 2 is a diagram of an example of the state of the data recording regions for 3D data files in the first and second data recording mediums 101, 102. 3D data 201 is composed of L/R image data files recorded on the first data recording medium 101 and the second data recording medium 102. The first and second data recording mediums 101, 102 that record data as files are generally composed of a system area in which file management information is recorded, and a user area in which the actual image data is recorded. The file management information includes information about the recording location of data files on a medium, file size, and so forth. A file system can manipulate data files by referring to this file management information. However, there may be a file system that records some of the file management information in the user area. In this case, even though the area in which the file management information is recorded is a user area, the file system still recognizes the file management information.

File deletion operations includes a method in which only file management information is deleted, and a method in which the actual image data recorded in the user area is deleted along with the file management information. The recovery processing of 3D data on the 3D data recovery device in Embodiment 1 is performed if only file management information has been deleted. In FIG. 2, the file management information is recorded in first and second system areas 202, 203. Also, data files, which are an example of actual image data, are recorded in first and second user areas 204, 205. For example, files A (L) to D (L) are recorded in the first user area 204, and files A (R) to D (R) are recorded in the second user area 205. In FIG. 2, a symbol 206 is assigned to a file A (L) which is a typical first user area 204, and a symbol 207 is assigned to a file A (R) which is a typical second user area 205.

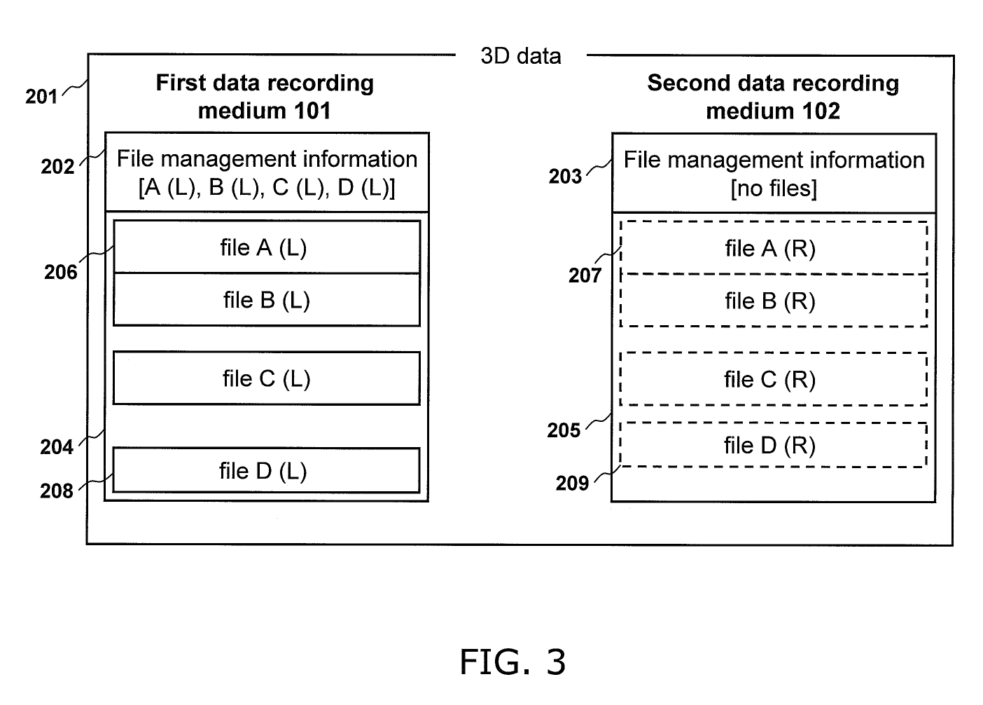

FIG. 3 is a diagram illustrating an example of the state of the first data recording medium 101, and of the state of the second data recording medium 102 for which media formatting has been executed. In FIG. 3, the media formatting deletes the file management information from the second system area 203 of the second data recording medium 102. However, the actual image data in the second user area 205, such as the files A (R) to D (R), remain as they were. If file management information is deleted, the file system cannot specify the actual recording region that is recorded on the second user area 205, such as the actual recording region of the files A (R) to D (R), so the files A (R) to D (R) cannot be recognized.

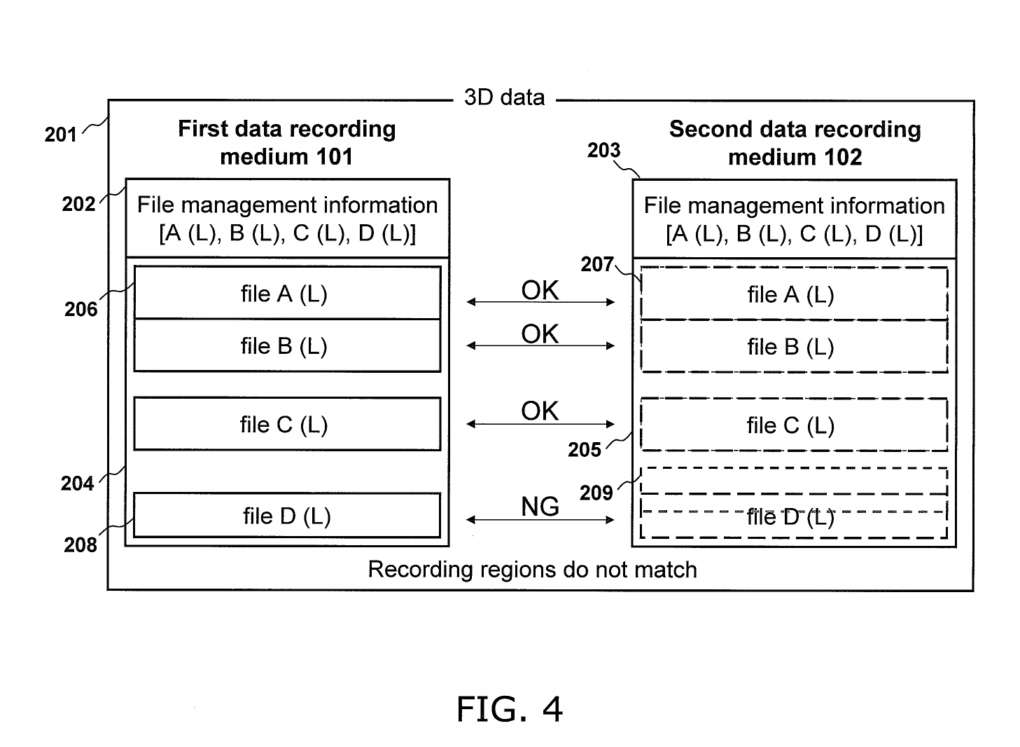

FIG. 4 is a diagram of a state in which the file management information of the first data recording medium 101 has been written over the second data recording medium 102 from which the file management information was deleted by media formatting. The file system recognizes files in the logical partition of the second data recording medium 102 by writing the file management information of the first data recording medium 101 over the file management information of the second data recording medium 102. This logical partition of the second data recording medium 102 is corresponding to the logical partition of the files recorded on the first data recording medium 101. That is, if the L/R image data recorded as 3D data are recorded on the same logical partitions of the first and second data recording mediums 101, 102, then even if the file management information is deleted from one, the file management information of the other can be used in place of the deleted file management information (the above-mentioned “file management information deleted from one”). As a result, it becomes possible for the file system to refer to data files.

For instance, in FIG. 4, the file system recognizes the files A (R), B (R), and C (R) by writing the file management information of the first data recording medium 101 over the second data recording medium 102. Meanwhile, in the first and second user areas 204, 205, the logical partitions of the file D (L) 208 and the file D (R) 209 are different. Accordingly, in this case even though the file system can recognize the files A (R), B (R), and C (R) by the over-writing of file management information, the file D (R) 209 cannot be properly recognized. The processing in this case will be described in detail for steps 110, 113 (S110, S113) as discussed below.

The A (R) to D (R) are file entities for the second data recording medium 102 in FIG. 4. However, since the file management information of the first data recording medium 101 is used in the second data recording medium 102 in FIG. 4, the file system recognizes the files A (R) to D (R) as the files A (L) to D (L). FIG. 4 shows this state. In FIG. 4, this state is expressed by enclosing the files A (L) to D (L), which are the file names recognized by the file system, with broken lines.

2: Operation of Data Recovery Device

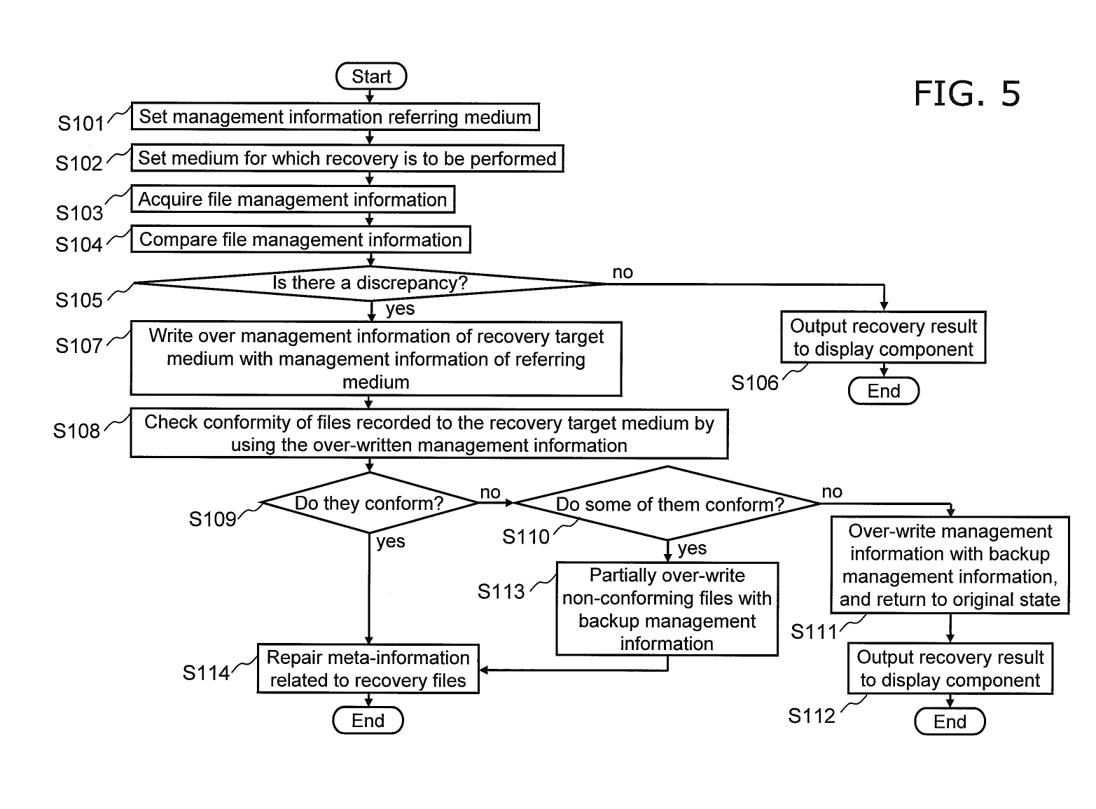

FIG. 5 is a flowchart of the processing of the 3D data recovery device according to Embodiment 1. If the file management information is deleted from one of the two data recording mediums 101, 102 on which 3D data has been recorded, the 3D data recovery device starts recovery processing on the data recording medium from which the file management information has been deleted (the recovery target medium).

In S101, a management information referring medium is designated. This management information referring medium is the medium that holds the file management information to be written over the recovery target medium. In S102, the recovery target medium is designated. There are two methods for designating the medium in S101 and S102. The two methods are manual setting by the user and automatic setting in the 3D data recovery device. With manual setting, the user designates either the management information referring medium or the recovery target medium, or both, by using the input unit 109.

In an example of automatic setting, either one of the interfaces 103, 104 connected to the first and second data recording mediums 101, 102 is designated as a dedicated interface for the management information referring medium. The other of the interfaces 103, 104 is designated as a dedicated interface for the recovery target medium. The management information referring medium and the recovery target medium are designed in this way.

In another example of automatic setting, information which records in each of the first and second data recording mediums 101, 102 is compared each other. The information includes the number of files or the recorded data size or the like. The data recording medium for which file deletion may have occurred is designated as the recovery target medium, and the other data recording medium is designated as the management information referring medium. More specifically, with the first and second data recording mediums 101, 102 on which only 3D data has been recorded, the data recording medium on which file deletion has been executed has a higher probability that the number of recorded files and the recorded data size will be small than other data recording medium.

The medium can thus be automatically designated by identifying the management information referring medium and the recovery target medium.

In S103, the CPU 106 acquires the file management information for the first and second data recording mediums 101, 102 on which 3D data has been recorded, and backs up this information in the memory 107 or the nonvolatile recording medium 108. As will be discussed below, if the file management information for the recovery target medium is over-written with the file management information of the management information referring medium, there is the possibility that the file management information backed up in S103 may be used as data for returning the over-written file management information to the original file management information.

In S104, the CPU 106 compares the file management information of the first and second data recording mediums 101, 102 acquired in S103. For example, the CPU 106 compares whether or not there is a discrepancy in the data size or the number of files recorded on each of the first and second data recording mediums 101, 102. If the CPU 106 can detect no discrepancy on the comparison processing of the management information in S104, the CPU 106 cannot determine that file deletion has occurred in either one of the first and second data recording medium 101, 102 in S105. In this case, in S106 the CPU 106 displays a message to the effect that recovery processing is being stopped, and ends the recovery processing.

If the CPU 106 detects a discrepancy in the file management information of the first and second data recording mediums 101, 102 on the comparison processing of the management information in S104, the CPU 106 over-writes the file management information of the recovery target medium with the file management information of the management information referring medium in S107. In S108, the CPU 106 checks a consistency of the files that can be referred to by over-writing of the file management information, that is, a consistency of the L/R image data files recorded on the first and second data recording mediums 101, 102. If the consistency between the L/R image data is confirmed, it is concluded that the image data acquired from the recovery target medium is valid. A specific example of a method for checking the consistency of L/R image data files will now be described in detail.

The sets of 3D data recorded on the first and second data recording mediums 101, 102 start and finish recording at the same time, so the number of video frames which are recorded on each of the first and second data recording mediums 101, 102 is also equal. That is, the CPU 106 determines whether or not the number of video frames of a image data file that has become referable by over-writing of file management information is equal to the number of video frames detected from the image data file of the management information referring side. Consequently, the CPU 106 checks the consistency of the L/R image data files which are recorded on the first and second data recording mediums 101, 102 and constitute the 3D data.

Also, the CPU 106 can determine a consistency of the L/R image data files with the frame size in place of the number of video frames. With image data in which time information is included in each frame header such as a time code (TC) or other, the CPU 106 determines whether or not the frame headers of two image data files corresponding to L/R video have the same time information. The CPU 106 thus checks the consistency of L/R image data files.

Also, file-specific meta-information such as a UMID (unique material identifier) or other is included in the file headers and footers. Accordingly, if there is a correlation between the meta-information for two L/R image data files in the first and second data recording mediums 101, 102, the CPU 106 determines whether or not correlated meta-information is detected based on the image data file that has become referable by over-writing of the file management information, and the image data file of the management information referring side. The CPU 106 thus checks the consistency of L/R image data files. Further, the CPU 106 may combine a plurality of the above-mentioned determination processing.

In regard to a consistency of individual files, such as a consistency of individual L image data files and a consistency of individual R image data files, the CPU 106 checks a consistency of the various image data files by using a verification tool for checking a consistency of image data files on the image data file that has become referable. Consequently, if an error should occur in an individual image data file, that image data file can be restored.

In S109, if the consistency of two image data files corresponding to L/R video is confirmed, the CPU 106 determines whether the image data files for which the consistency is not confirmed are all of the image data files that have become referable, or are just some of the image data files in all the image data files that have become referable in S110. Here, if the CPU 106 determines that consistency is not confirmed in all of the image data files, the CPU 106 returns the file management information of the recovery target medium to the file management information prior to over-writing in S111. The file management information prior to over-writing is the original file management information backed up in S103. Then the CPU 106 displays message to the effect that recovery processing is being stopped in S112, and ends the recovery processing.

In S110, if the CPU 106 determines that the consistency is not confirmed in some of the image data files, the CPU 106 returns the file management information for the image data files in which no consistency was confirmed to the file management information of the recovery target medium prior to over-writing in S113. The file management information of the recovery target medium prior to over-writing is the original file management information backed up in S103. As to the image data files for which consistency is confirmed, the CPU 106 holds the file management information for the recovery target medium. Consequently, just the image data files for which consistency has been confirmed become referable.

At the stage of S114, it has been confirmed that all of the referable image data files conform and are valid as image data files. However, depending on the 3D data recording method, it may be necessary to repair the meta-information. More specifically, with an ordinary file system, the file name is included in the file management information. Accordingly, the file name of a image data file that has become referable due to the over-writing of file management information, that is, the file name of a image data file that has become referable in the recovery target medium, is replaced with the file name included in the file management information of the management information referring medium. Therefore, if there is a naming rule for two file names corresponding to L/R video in a recording device, the file name of the image data file of the recovery target medium is changed according to this specific naming rule.

If there is no naming rule, that is, if there is no need for repair of meta-information of the image data file of the recovery target medium, then S114 may be omitted.

As discussed above, with the 3D data recovery method in this embodiment, even if one of the two data recording mediums 101, 102 on which 3D data has been recorded undergoes media formatting, the image data constituting the L/R video can be recovered as a referable data file.

### Other Embodiments

Embodiment 1 was an example of embodiments of the present technology, but the present technology is not limited to or by Embodiment 1. Other embodiments of the present technology are described below. Furthermore, the present technology is not limited to or by the other embodiments given below, and can be applied to suitably modified embodiments as well.

As shown in FIG. 1, in Embodiment 1 an example was described in which the interfaces 103 and 104 were provided to the two data recording mediums 101, 102, respectively. Instead, a single interface may be provided to the two data recording mediums 101, 102. In this case, first the management information referring medium is mounted to the interface, and file management information of this management information referring medium is acquired. Then, the management information referring medium is removed from the interface. After this, the recovery target medium is mounted to the interface, and the file management information of the recovery target medium is acquired.

Thus, 3D data can be recovered just as in Embodiment 1 by acquiring the file management information for the management information referring medium and the file management information for the recovery target medium, and executing the processing after S103 in FIG. 5.

Also, as shown in FIG. 3, in Embodiment 1 an example was given of a case in which all of the file management information was deleted from the second system area 203 of the second data recording medium 102. Besides this situation, the present technology can also be applied to a case in which only part of the file management information is deleted from the second system area 203 of the data recording medium 102.

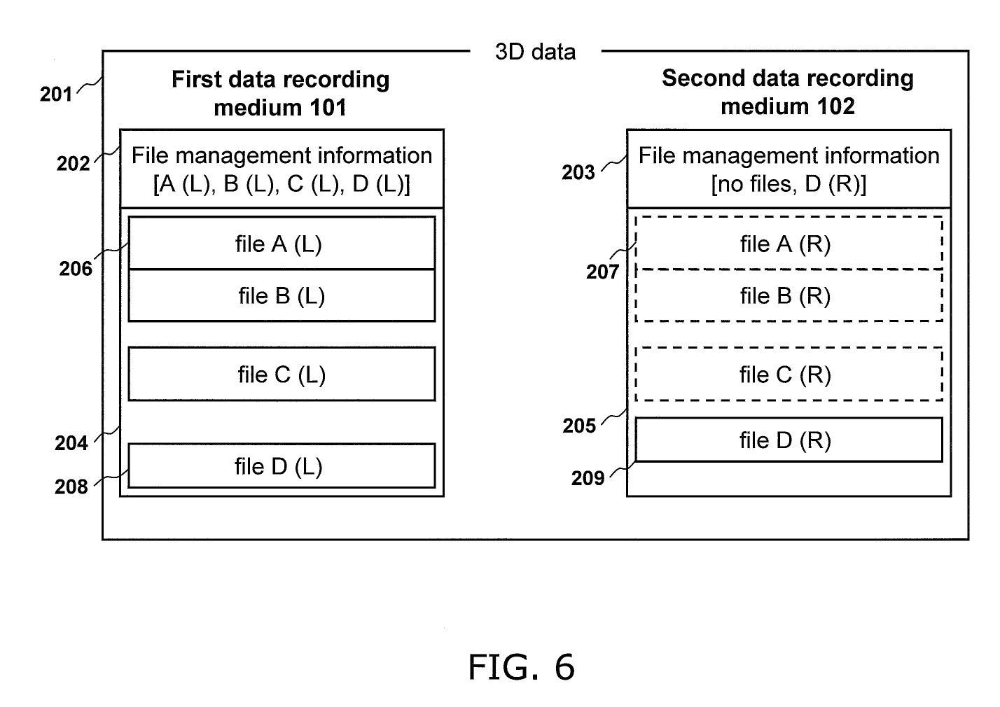

An example will now be described of a case in which the file management information A (R) to C (R) is deleted from the second data recording medium 102, and the file management information D (R) remains (see FIG. 6). Here again, just as in Embodiment 1, in S107 the file management information of the first data recording medium 101 is written over the file management information of the second data recording medium 102. The result is that the files A (R) to D (R) of the second data recording medium 102 become referable.

Here, if some of the files do not conform, the processing of S113 is executed. For example, if there is a lack of consistency between the file D (L) of the first data recording medium 101 and the file D (R) of the second data recording medium 102 as shown in FIG. 4, the processing of S113 is executed. That is, the file management information D (R) of the second data recording medium 102 that was backed up in S103 is used as the file management information of the second data recording medium 102. Consequently, all of the files A (R) to D (R) become referable.

The 3D data recovery method executed by the 3D data recovery device according to Embodiment 1 can also be constituted by a computer program that is executed by a computer. Also, the computer program in this 3D data recovery method may be recorded on a recording medium that can be read by a computer. Such recording mediums include magnetic disks, optical discs, opto-magnetic disks, IC cards, and semiconductor memories. More specifically, recording mediums include flexible disks, hard disks, CD-ROMs, DVDs, DVD-ROMs, DVD-RAMS, and BDs (Blu-Ray Discs®).

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of 3D data recovery device, 3D data recovery method, and 3D data recovery program. Accordingly, these terms, as utilized to describe the present invention should be interpreted relative to 3D data recovery device, 3D data recovery method, and 3D data recovery program.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### INDUSTRIAL APPLICABILITY

In the 3D data recovery device according to the above embodiments, if the management information of one recording medium is unavailable, this management information can be recover by utilizing the management information of the other recording medium. This form of data recovery can be applied to 3D imaging devices that handle 3D data, editing devices, and recovery devices.

What is claimed is:

1. A 3D data recovery device comprising:
a recording medium control unit configured to access a first recording medium on which first data is recorded and a second recording medium on which second data is recorded, the first and second data constituting 3D data;
a management information acquisition unit configured to acquire management information related to the second data from the second recording medium if management information related to the first data on the first recording medium is unavailable;
a data acquisition unit configured to acquire the first and second data recorded on the first and second recording mediums, respectively, based on the management information acquired from the second recording medium; and
a data check unit configured to check a consistency of the first and second data as 3D data and determine whether the first data acquired from the first recording medium is valid, based on information in the first and second data acquired from the first and second recording mediums, respectively.

2. The 3D data recovery device according to claim 1,
wherein the management information acquisition unit is configured to acquire file management information as the management information related to the first and second data,
the data acquisition unit is configured to acquire the first and second data recorded on the first and second recording mediums, respectively, based on the file management information acquired from the second recording medium, and
the data check unit is configured to check the consistency of the first and second data as 3D data and determine whether the first data acquired from the first recording medium is valid by utilizing file information as the information in the first and second data acquired from the first and second recording mediums, respectively.

3. The 3D data recovery device according to claim 2, further comprising:
a management information resetting unit configured to return the management information corresponding to a part of the first data of the first recording medium to an initial management information if a part of the first data acquired from the first recording medium is inconsistent with the second data acquired from the second recording medium as 3D data.

4. The 3D data recovery device according to claim 2, wherein the data check unit is configured to use a UMID (unique material identifier) that uniquely identifies at least a part of the first and second data, file header information, a number of frames, a frame size, frame header information, or file footer information as the file information.

5. The 3D data recovery device according to claim 3, wherein the data check unit is configured to use a UMID (unique material identifier) that uniquely identifies at least a part of the first and second data, file header information, a number of frames, a frame size, frame header information, or file footer information as the file information.

6. A 3D data recovery method used with first and second data constituting 3D data, the first data is recorded on a first recording medium, the second data is recorded on a second recording medium, and the first data on the first recording medium is acquired if management information related to first data on the first recording medium is unavailable, the method comprising:
accessing the first and second recording mediums;
acquiring management information related to the second data from the second recording medium;
acquiring the first and second data recorded on the first and second recording mediums, respectively, based on the management information acquired from the second recording medium; and
checking a consistency of the first and second data as 3D data and determining whether the first data acquired from the first recording medium is valid, based on information in the first and second data acquired from the first and second recording mediums, respectively.

7. The 3D data recovery method according to claim 6, wherein the information used for checking the consistency of the first and second data as 3D data is a UMID (unique material identifier) that uniquely identifies at least a part of the first and second data, file header information, a number of frames, a frame size, frame header information, or file footer information.

8. A program stored on a non-transitory computer-readable medium for causing a computer to execute a 3D data recovery method used with first and second data constituting 3D data, the first data is recorded on a first recording medium, the second data is recorded on a second recording medium, and the first data on the first recording medium is acquired if management information related to first data on the first recording medium is unavailable, the program comprising code operable to cause the computer to perform:
accessing the first and second recording medium;
acquiring management information related to the second data from the second recording medium;
acquiring the first and second data recorded to the first and second recording mediums, respectively, based on the management information acquired from the second recording medium; and
checking a consistency of the first and second data as 3D data and determining whether the first data acquired from the first recording medium is valid, based on information in the first and second data acquired from the first and second recording mediums, respectively.

9. The program stored on a non-transitory computer-readable medium according to claim 8, wherein the information used for checking the consistency of the first and second data as 3D data is a UMID (unique material identifier) that uniquely identifies at least a part of the first and second data, file header information, a number of frames, a frame size, frame header information, or file footer information.
